(19) United States
(12) Patent Application Publication
(10) Pub. No.: US 2007/0101420 A1
(43) Pub. Date: May 3, 2007

(54) Job processing system, instruction creating device, and image reading device

(76) Inventor: Takanori Masui, Ebina-shi (JP)

Correspondence Address: GAUTHIER & CONNORS, LLP, 225 FRANKLIN STREET, SUITE 2300, BOSTON, MA, 02110, US

(21) Appl. No.: 11/401,090

(22) Filed: Apr. 10, 2006

(30) Foreign Application Priority Data
Nov. 2, 2005 (JP) 2005-319180

(51) Int. Cl. H04L 9/32

(52) U.S. Cl. 726/10

(57) ABSTRACT

There is provided a job processing system having an instruction creating device and an image reading device. The instruction creating device includes a section that accepts designation of a public key certificate of a user having full access rights with respect to an electronic document file, and a section that creates reading instruction data including data indicating the operation restriction and the designated public key certificate of the user having full access rights. The image reading device includes a section that detects data indicating an operation restriction and a public key certificate of a user having full access rights, and a section that sets an operation restriction, on the basis of the read data to an electronic document file representing an image obtained by reading a document and that sets, a user having full access rights, on the basis of the read data to the electronic document file representing the image.

### PRIORITY INFORMATION

This application claims priority to Japanese Patent Application No. 2005-319180, filed on Nov. 2, 2005, which is incorporated herein by reference in its entirety.

### BACKGROUND

1. Technical Field

The present invention relates to an image reading device such as a digital multifunction center, a digital copier, or a network scanner, and, in particular, to an image reading device which can set information on operation restriction to a file of an image which is read.

2. Related Art

In recently developed, available file formats, information on restriction of operations such as printing prohibition and editing prohibition can be included in a file; examples of such formats include PDF (Portable Document Format) developed by Adobe Systems Inc. of U.S.A. and XDW (DocuWorks) format developed by Fuji Xerox Corporation. For example, Acrobat (registered trademark), which is a software application developed by Adobe Systems, allows designation of an operation restriction to a PDF file from a UI (user interface) screen. When an electronic document file to which an operation restriction is added is opened by means of editor software, the editor software allows only operation by the user within the operation restriction. Therefore, employing PDF or XDW format as the format of a document to be distributed enables creation and distribution of an electronic document which can be used only within the range intended by the distributor.

In the formats such as the PDF and the XDW format, a user having full access rights to the file can be designated as an exception to the operation restriction. The user having full access rights can change the setting of operational rights of the file. In order to identify the user having full access rights, PKI (public key infrastructure) techniques are used. In other words, a subject DN (Distinguished Name) of the user having full access rights designated by the file creator is encrypted by means of a public key of the user having full access rights and incorporated into the file of the PDF or the XDW format. The user having full access rights can, by means of his or her private key, correctly decode the subject DN of the user having full access rights within the file. Because the subject DN matches the DN of the user, the editor application can correctly recognize the user as a user having full access rights for the file. In this scheme, when a user having full access rights is to be set with respect to an electronic document file such as a PDF file, there must be employed a public key certificate which indicates the subject DN and public key of the user having full access rights.

Many recent image reading devices such as multifunction centers include functions to convert scanned image data of a scanned document into an electronic document file such as a PDF file and distribute the electronic document file to a designated destination through an electronic mail or store the electronic document file in a distribution server via a network. In these types of image reading devices, setting an operation restriction on an electronic document file of a scanned image requires input through an input device which is less capable than a personal computer, such as numerical keys on a control panel, a soft keyboard displayed on a liquid crystal touch panel, or GUI (graphical user interface) buttons. Thus, there is a problem in that the work required of the user becomes complex.

### SUMMARY

According to one aspect of the present invention, there is provided a job processing system having an instruction creating device and an image reading device. In this system, the instruction creating device has a section that accepts designation of a public key certificate of a user having full access rights with respect to an electronic document file including a read image, and a section that creates reading instruction data including data indicating a designated operation restriction and data indicating the designated public key certificate of the user having full access rights. The image reading device has a section that detects, from reading instruction data, data indicating the designated operation restriction and data indicating the public key certificate of the user having full access rights when the section receives a document reading instruction by the reading instruction data, and a section that sets, when the data indicating the operation restriction are detected from the reading instruction data, an operation restriction based on the read data to an electronic document file representing an image obtained by reading a document and that sets, when the data indicating the public key certificate of the user having full access rights are detected from the reading instruction data, a user having full access rights, on the basis of the read data to the electronic document file representing the image obtained by reading the document.

According to another aspect of the present invention, there is provided a job processing system having an instruction creating device and an image reading device. In this system, the instruction creating device has a section that creates certificate repository instruction data including data of one or more public key certificates, and the image reading device has a section that displays, on a display screen of the image reading device, a list of public key certificates included in input certificate repository instruction data and accepts selection of a public key certificate to be used by a user from the list, and a section that encrypts, by means of the selected public key certificate, an electronic document file representing an image obtained by reading a document or sets, by means of the selected public key certificate, a user having full access rights to the electronic document file representing the image obtained by reading the document.

### BRIEF DESCRIPTION OF THE DRAWINGS

These and other aspects of the disclosure will become apparent from the following description read in conjunction with the accompanying drawings, wherein the same reference numerals have been applied to like parts and in which:

FIG. 1 is a diagram exemplifying a system structure according to an embodiment of the present invention;

FIG. 2 is a diagram showing an example of instruction data according to the embodiment;

FIG. 3 is a diagram showing an example display of a user interface screen of an instruction editor;

FIG. 4 is a flowchart showing processing by the instruction editor;

FIG. 5 is a flowchart showing processing when a multifunction center processes an instruction which instructs a scan process;

FIG. 6 is a diagram showing an example of instruction data including certificate repository information; and

FIG. 7 is a flowchart showing processing when a multifunction center processes instruction data including certificate repository information.

### DETAILED DESCRIPTION

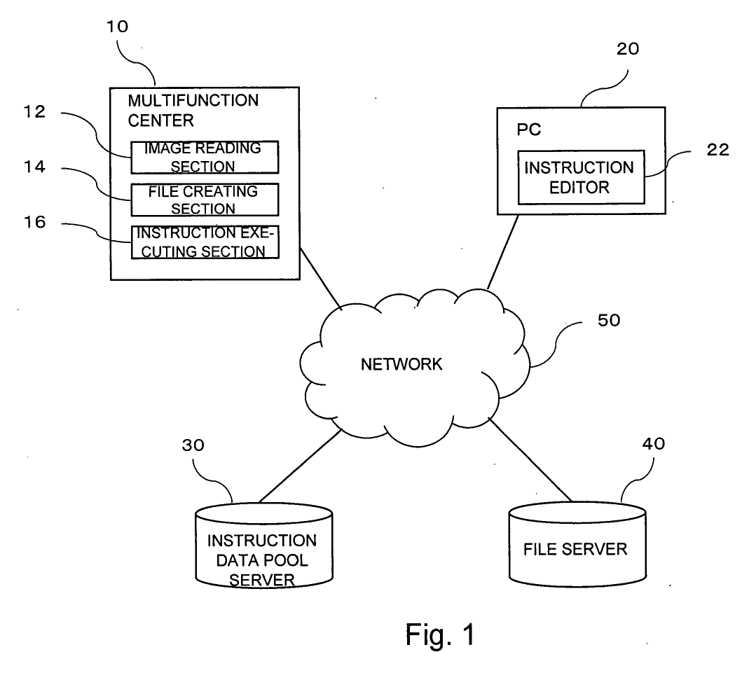

FIG. 1 is a diagram schematically showing a job processing system according to an embodiment of the present invention. As shown in FIG. 1, in this system, a multifunction center 10, a PC (personal computer) 20, an instruction pool server 30, and a file server 40 are connected to a network 50 such as the Internet or a LAN (local area network).

The multifunction center 10 is a device which has functions of a scanner, a printer, a copier, etc. and has a function to execute a process indicated in given instruction data. In the multifunction center 10, an image reading section 12 is a section that reads a paper document which is set on an automatic document feeder or a platen. A file creating section 14 is a section that creates a file of a predetermined electronic document file format such as PDF or XDW, which includes an image of a document read by the image reading section 12. An instruction executing section 16 is a section that interprets given instruction data and executes the instruction contents indicated in the instruction data, and is typically realized by software. Interpretation of the instruction data and execution of processes on the basis of the interpretation of the instruction data are described in US-2004-0194108-A1 and will not be described in detail here.

The PC 20 is a computer used by the user and to which an instruction editor 22 for creating the instruction data is installed.

The instruction pool server 30 is a server to which instruction data created by the users are stored. The multifunction center 10 can download instruction data stored in the instruction pool server 30 and execute the instruction.

FIG. 1 also shows the file server 40 as an example of a storage destination of an electronic document file created from an image scanned by the multifunction center 10.

The file creating section 14 of the multifunction center 10 has a function to set an operation restriction to a file when an electronic document file such as a PDF file representing a scanned image is created. The operation restrictions include, for example, prohibition of printing of the file and prohibition of editing of the file. The file creating section 14 also has a function to set a user having full access rights who can cancel the operation restriction which is set to a file.

In the present embodiment, the operation load imposed on the user who sets the operation restriction or the user having full access rights is reduced with the use of the instruction data when the operation restriction or the user having full access rights is set.

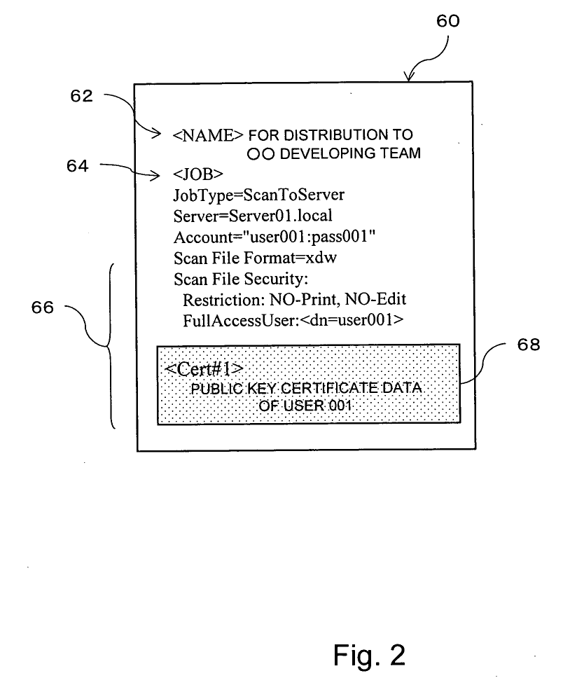

FIG. 2 shows an example of instruction data 60 including a setting instruction for an operation restriction and a user having full access rights to the file in the present embodiment.

The instruction data 60 of FIG. 2 contains a name of instruction data 62 and a job content description 64. The name of instruction data 62 is a text string described following a tag “<NAME>” and is used by the user to identify each instruction. The job content description 64 is a description showing contents of the process designated in the instruction; that is, a “job,” and includes a description of “JobType” indicating the type of the job. The job type “ScanToServer” in the exemplified configuration indicates a job in which an image scanned by the image reading section 12 is stored in the server as an electronic document file. Description of parameters of the job follows the description of the job type. The parameter “Server” is identification information of the server, on the network 50, into which the created electronic document file is to be stored (for example, the file server 40). The parameter “Account” is information indicating an account for storing the file to the server, and is, for example, a pair consisting of a user name and a password. The parameter “Scan File Format” is a file format of the electronic document file to be created and may be selected from formats such as, for example, XDW and PDF.

A parameter “Scan File Security” 66 is a parameter indicating contents of security setting with respect to the electronic document file of the scanned image and includes detail parameters of “Restriction” and “FullAccessUser.” The parameter “Restriction” is a parameter indicating contents of the operation restriction with respect to the file, and “NO-Print” indicates “prohibition of printing” and “NO-Edit” indicates “prohibition of editing.”

The parameter “FullAccessUser” is identification information of a user having full access rights who is a special user who can cancel the operation restriction. In the exemplified configuration, DN (Distinguished Name) which is used in X.509 certificate or the like is used as the identification information of the user having full access rights (the description of DN is relatively long and, thus, DN is represented in the drawings in simplified form because full description of DN would make the drawings complicated) . Public key certificate data 68 of the user having full access rights is added following the description of the user having full access rights. The public key certificate data 68 is used when the user having full access rights is set in the multifunction center 10.

The instruction data exemplified in FIG. 2 indicate a process to store the file of a scanned image to a designated server. Processes that involve scanning additionally include a case in which the file of the scanned image is transmitted to a designated destination by an electronic mail. In this case, in the instruction data, the electronic mail address of the destination is described as a parameter in place of the address of the server and the account. When the file is to be encrypted by means of a public key of the destination, a public key certificate of the destination is incorporated into the instruction data.

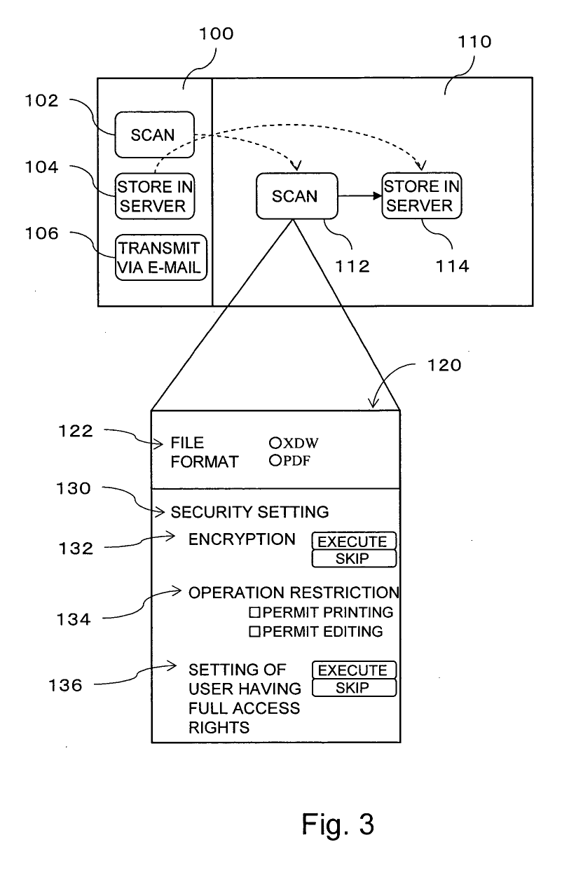

The user edits the instruction data by means of the instruction editor 22 installed in the PC 20. FIG. 3 exemplifies a display of a user interface screen of the instruction editor 22. This screen is displayed on a display device of the PC 20.

The user interface screen includes a component window 100 and an assembly window 110. In the component window 100, icons 102, 104, and 106 each indicating a unit process which is a construction unit of a job are shown. In the illustrated configuration, only the element icons of jobs related to scanning are shown. In the assembly window 110, a required element icon 102, 104, or 106 is placed by, for example, a drag-and-drop process from the component window 100. By placing multiple element icons in the assembly window 110 and defining the execution order by operations such as connection between the element icons by arrows, a user can define a job as a system of multiple unit processes. In the illustrated example, a “store in a server” icon 114 is connected following a “scan” icon 112, to define a job in which a document is scanned and stored in a server.

When the icon 112 or 114 placed in the assembly window 110 is selected by a click operation or the like, a setting screen for setting a process parameter with respect to individual unit process corresponding to each icon is called. In the illustrated configuration, a parameter setting screen 120 of a scan process is shown.

The screen 120 includes a designation field 122 of a file format of the electronic document to which the scanned image is to be stored and a field 130 for setting security for the file. The designation field 122 of file format allows designation of one of the XDW format and the PDF format by means of a radio button.

In the illustrated configuration, the field 130 of the security setting includes a designation field 132 for specifying whether or not file encryption is required, a designation field 134 for an operation restriction, and a setting field 136 for a user having full access rights. In the designation field 132 for specifying whether or not file encryption is required, a GUI button for instructing to “execute” encryption or “skip” (not execute) encryption is shown. In this configuration, as the encryption method, methods such as public key cryptography are considered. In other words, the encryption is an encryption using a public key of the user to which the file is to be provided. When the “skip” button is selected through, for example, a click operation, the instruction does not contain an instruction for encryption of the file. When, on the other hand, the “execute” button is selected, a screen (not shown) is displayed for accepting designation of a public key certificate of the user to which the file is to be provided. This screen shows a list of public key certificates installed in the PC 20 and an input field for search conditions to access the directory server and search for the public key certificate. When the creator of the instruction selects one of more public key certificates of the user(s) who is the provision destination of the file from the list of the installed public key certificates or from the list of public key certificates found in the directory server, the selected public key certificate is incorporated into the instruction data as information including a key for encryption. FIG. 2 shows a case when the encryption of the file is not to be executed.

In the illustrated configuration, in the designation field 134 for operation restriction, checkboxes for two items of “permit printing” and “permit editing” are shown. In other words, the illustrated configuration corresponds to a case in which, in a default setting, both printing and editing are prohibited. The instruction creator can enter, through a click operation of a mouse or the like, a check mark in the checkbox “permit printing” when the instruction creator intends to allow printing of the file and in the checkbox “permit editing” when the instruction creator intends to allow editing of the file. When no mark is entered in the checkbox corresponding to the operation (such as printing or editing), the operation remains prohibited.

In the setting field 136 for a user having full access rights, a GUI button is provided for instructing to “set” or “skip” the user having full access rights. When the “skip” button is selected, no user having full access rights is set in the instruction. When, on the other hand, the “set” button is selected, a screen (not shown) for accepting a designation of a public key certificate of a user to be set as the user having full access rights is displayed. Similar to the designation screen for the public key certificate for encryption, the list of the public key certificates installed in the PC 20 or a screen for searching the directory server for the public key certificates are shown in this screen. When the instruction creator selects, from the list or from the search result, one or more public key certificates of one or more users to be made the user(s) having full access rights, the selected public key certificate is incorporated into the instruction data.

The setting screen has been described by reference to an example case of the “scan” button 112 being clicked. When the “store in server” button 114 is clicked, a setting screen of parameters (for example, address of the storage destination server and account information of the user who is storing the file) is similarly displayed, and instruction data are created on the basis of the contents which are set with respect to the displayed screen.

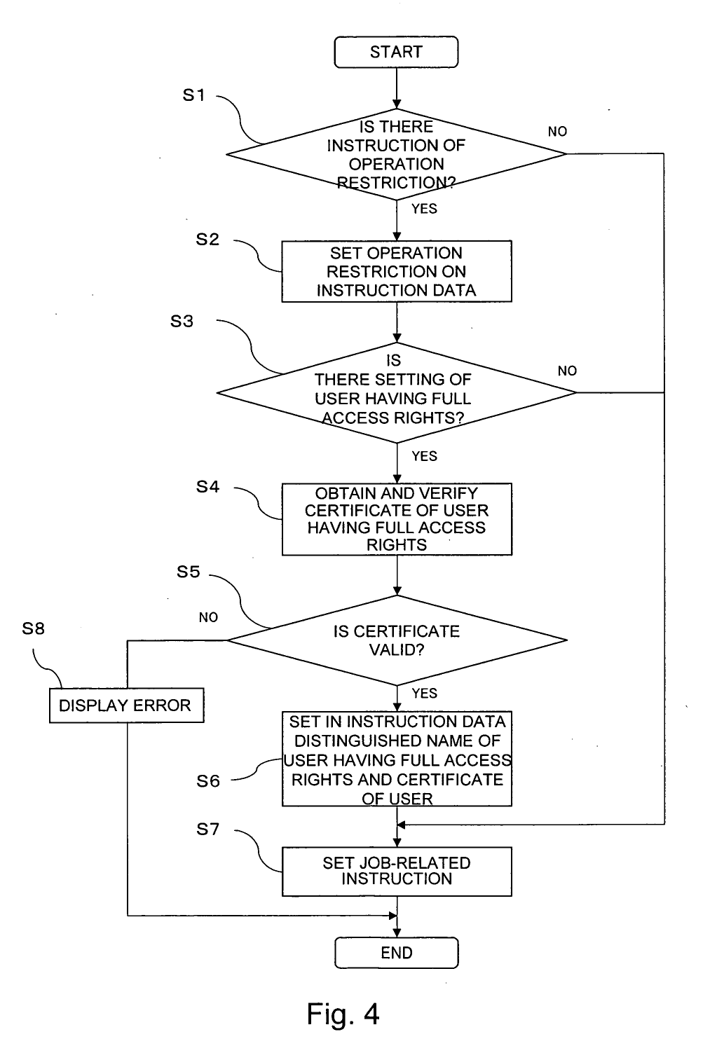

The instruction editor 22 creates the instruction data in response to an instruction from an instruction creator as described above. This procedure will now be described by reference to FIG. 4.

In this procedure, the instruction editor 22 first determines whether or not there is an instruction of an operation restriction from an instruction creator (S1). In the example configuration of the parameter setting screen 120 shown in FIG. 3, a configuration is employed in which all operations of printing and editing are prohibited in a default setting and the instruction creator instructs the operations to be permitted by placing a mark in a checkbox. Therefore, the determination result at step S1 becomes NO only when a mark is placed in both checkboxes for “permit printing” and “permit editing,” because no restriction is placed on the operations only in this situation. In all other cases, some restriction remains with respect to at least some of the operations, and, thus, the determination result in step S1 becomes YES.

When an operation restriction is imposed, the instruction editor adds a description of the operation restriction to the instruction data (S2). In the example instruction data of FIG. 2, when both restrictions of the print prohibition and edit prohibition remain, for example, a description of “Restriction: NO-Print, NO-Edit” is added in the field of “Scan File Security” of instruction data.

When an operation restriction is not designated, the instruction editor 22 sets, in the instruction data, data regarding instruction contents related to the job other than the instructions related to security (S7). For example, when the “scan” icon 112 and the “store in server” icon 114 are connected in the assembly window 110 in this order, the instruction editor 22 adds in the instruction data a text string of “ScanToServer” following a tag “<JobType>” indicating a job type. The instruction editor 22 also adds a description of an address of the storage destination server and account information for logging on the server. Although not shown, when the creator inputs a text string of the name into the input field of the name of instruction data, the instruction editor 22 adds a description of the text string following and to the right of the “<NAME>” tag. The instruction editor 22 also adds to the instruction data a description of the file format of the scanned image.

When in step S2 data of operation restriction are set in the instruction, the instruction editor 22 then determines whether or not the instruction creator has designated a user having full access rights (S3).

When no user having full access rights has been designated, processing proceeds to step S7, and the instruction editor 22 adds in the instruction the instruction contents related to the job.

When, on the other hand, a user having full access rights is designated, a public key certificate of the user having full access rights is obtained and verified (S4). The verification is executed in order to check whether or not the certificate can be trusted and whether or not the certificate is valid at this point. More specifically, there are performed processes such as authentication path validation of the certificate, checking of the term of validity shown in the certificate, and checking of whether or not the certificate is on a Certificate Revocation List. Not all of these processes need to be processed, and suitable verification processes can be performed in consideration of a balance between a degree of security required for the system and the processing load. When multiple users having full access rights are designated, the verification process is performed for each user having full access rights.

The result of the verification is determined in step S5. When all public key certificates of the designated users having full access right are determined as valid, the instruction editor 22 incorporates in the instruction data the distinguished name (DN) of each user having full access rights and the public key certificate data (S6) . Processing then proceeds to step S7, and instruction contents related to the job are added to the instruction.

When, on the other hand, in step S5 the instruction editor 22 determines that any of public key certificates for the designated users with full access is invalid, the instruction editor 22 displays a predetermined error (S8) . The error display may be, for example, a display of a message indicating that an invalid public key certificate is designated.

In the above-described configuration, the error is displayed when any of the public key certificates of the designated users having full access rights is invalid. Alternatively, it is also possible to execute processing to incorporate the distinguished name and public key certificate of only user(s) having full access rights and having a valid public key certificate.

In the above-described configuration, encryption is not described. When encryption is selected through the designation field 132 for specifying whether or not encryption is required on the parameter setting screen 120 (refer to FIG. 3) and the public key certificate of the user to which the file is to be provided is designated, the instruction editor 22 incorporates into the instruction data the setting information of the encryption of the file (for example, designation of an encryption algorithm) and the public key certificate.

The instruction data created by the instruction editor 22 in this manner is stored in a predetermined instruction pool server 30, for example, via the network 50.

The instruction pool server 30 provides each stored instruction data set to a user in response to a request from the user. In the provision process, the instruction pool server 30 manages access rights of the user. More specifically, the account of the instruction creator and the user who uses the instruction are registered in the instruction pool server 30. The instruction creator can set, in the instruction pool server 30, the access rights with respect to the instruction data created and stored by the instruction creator. The access rights can be given in units of users or in units of groups. Information on access rights with respect to the instruction data is managed by the instruction pool server 30 as an access control list (ACL) or the like, which is known. When the instruction pool server 30 is accessed by a user, the instruction pool server 30 authenticates the user, and, when authentication is successful, the instruction pool server 30 creates, on the basis of the ACL, a list of instructions for which the user has an access right and provides the list to the user. The list includes, for example, the names of the corresponding instructions, and the user determines a desired instruction from the list of the names. Alternatively, it is also possible to employ a configuration in which attribute information such as a name of creator, date and time of creation, and a job type of the instruction is displayed in addition to the name of the instruction to facilitate user's determination. The user can select from the list an instruction that the user wishes to use.

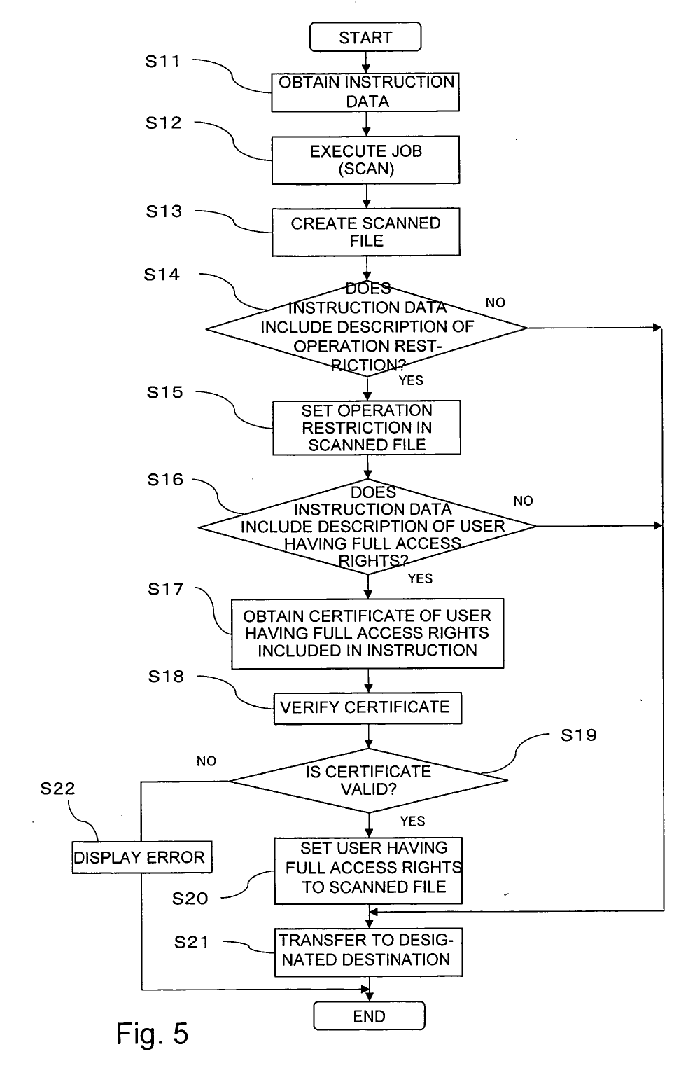

In the present embodiment, a case is considered in which the user downloads to the multifunction center 10 instruction data for scanning a document from the instruction pool server 30 and uses the instruction data. FIG. 5 shows the processing in this case.

The instruction executing section 16 of the multifunction center 10 obtains instruction data showing processes including scanning, and, when an instruction of job execution is received from a user, instructs the image reading section 12 to scan a document which is set on a document auto-feeder or on a platen (S12). The file creating section 14 creates an image obtained as a result of the scanning as a file of a file format designated in the instruction data (hereinafter referred to as “scanned file”) (S13) . The instruction executing section 16 determines whether or not the instruction contains a description of an operation restriction (S14), and, when there is no description of the operation restriction, transfers the scanned file to a destination (server or electronic mail address) designated in the instruction (S21).

When there is a description of an operation restriction, the instruction executing section 16 instructs the file creating section 14 to set the operation restriction to the scanned file (S15). The file creating section 14 has a capability to set an attribute to the file of the designated file format and sets the operation restriction (printing prohibition, editing prohibition, or both) by means of this capability.

The instruction executing section 16 checks whether or not the instruction includes a description of a user having full access rights (S16), and, when there is no description of a user having full access rights, transfers to the designated destination the scanned file to which the operation restriction is set (S21). When, on the other hand, the instruction includes a description of a user having full access rights, the public key certificate data 68 of the user included in the instruction is obtained (S17) and the validity of the certificate data 68 is verified (S18) . In this step, one or more predetermined processes are performed among processes such as, for example, verification of authentication path, verification of term of validity, and checking of a certificate revocation list. The validity of the certificate data 68 is determined on the basis of the result of the verification (S19), and, when the certificate data 68 is determined to be valid, the instruction executing section 16 instructs the file creating section 14 to set the user having full access rights to the scanned file (S20) . When the file creating section 14 receives the command, the file creating section 14 encrypts the distinguished name (DN) shown in the public key certificate of the user having full access rights by means of a public key included in the public key certificate and stores the encrypted distinguished name in a list of the users having full access rights, which is attribute information of the scanned file. The scanned file to which the user having full access rights is set in this manner is then transferred to the designated destination (S21).

When it is determined in step S19 that the certificate data 68 is not valid, the instruction executing section 16 displays an error on the display device of the multifunction center 10 including a message indicating that the public key certificate is not valid (S22).

When one instruction data set designates more than one user having full access rights, a determination is made as to whether or not the public key certificate is valid for each designated user having full access rights (S19), and, when the public key certificate is valid, the user can be registered in the list of users having full access rights of the scanned file (S20). When public key certificate of any of the users having full access rights designated in the instruction data is no longer valid, the user is not registered in the list of users having full access rights of the scanned file. Alternatively, it is also possible to employ a configuration in which, when there is an invalid public key certificate corresponding to a user among the users having full access rights designated in the instruction data, the scanned file is not transferred (S21) and an error is displayed (S22).

The scanned file to which at least one of an operation restriction and user having full access rights is set can be opened by means of viewing software for viewing the scanned file and editing software for editing the scanned file. In this process, if the user using the software is a user having full access rights set for the file, the distinguished name of the user in the list of the users having full access rights can be decoded by means of a private key of the user within the PC of the user and the decoded distinguished name matches the distinguished name of the user. Thus, the software recognizes the user as a user having full access rights and permits canceling of the operation restriction which is set for the file.

In the processing illustrated in FIG. 5, a case is not considered in which there is a setting in the instruction data for encryption of the scanned file. If such a case is to be considered, the instruction executing section 16 instructs the file creating section 14 to encrypt the contents of the scanned file when encryption is instructed in the instruction. In this process, the file creating section 14 creates, for example, a session key (for example, randomly), encrypts the contents of the scanned file through symmetric key cryptography using the session key, encrypts the session key by means of a public key indicated in the public key certificate for encryption incorporated in the instruction, and incorporates the encrypted session key into the encrypted scanned file. When multiple public key certificates are designated in the instruction data for encryption, a list of encrypted session keys, each of which is encrypted by means of the public key of individual certificate, may be incorporated into the scanned file. The user who obtained the scanned file can decode the contents of the scanned file by means of a decoded session key if the user can decode one of the encrypted session keys in the scanned file by means of the user's private key.

According to the above-described embodiment, because an operation restriction with respect to the scanned file is described in the instruction data for instructing creation of a scanned file, the user can input suitable instruction data to the multifunction center 10 to execute the instruction, and thus, the user is not required to set operation restrictions in detail through the user interface screen of the multifunction center 10.

Because the instruction data contains the public key certificate of the user having full access rights, even when the multifunction center 10 does not have the public key certificate of the user having full access rights, the public key certificate can be obtained from the instruction data and the user having full access rights can be set for the scanned file.

In the present embodiment, because the instruction data downloaded from the instruction pool server 30 include the public key certificate of the user having full access rights, the operation can be simplified as compared with a configuration in which the public key certificate of the user having full access rights is obtained through searching the directory server such as an LDAP server. More specifically, when the directory server is searched for the public key certificate, the user must be authenticated by the instruction pool server 30 for obtaining the instruction and also by the directory server for searching for the certificate. Because the authentication information sets for these servers generally differ from each other, the operational load imposed on the user is significant. According to the present embodiment, on the other hand, because the user can obtain an instruction including the public key certificate of the user having full access rights by passing the authentication of the instruction pool server 30 alone, the operational load for authentication is low.

In the above-described configuration, print prohibition and edit prohibition are exemplified as operation restrictions with respect to the scanned file, but the operation restriction is not limited to these restrictions.

Moreover, although a configuration is exemplified in which “operation restriction” is set with respect to a scanned file, as is easily understood by a person with ordinary skill in the art, it is also possible to apply the above-described process to a case when “operation authority” restrictively listing operation items to be permitted is set with respect to a scanned file. Setting of an operation restriction to a file and setting of an operation authority to a file are technically equivalent. When the operation authority is set to the file, the user having full access rights is a user who can change the setting of the operation authority.

The above-described embodiment concerns instruction data in which information on an operation restriction or on a user having full access rights is incorporated into a scanned file. A case in which the instruction is used as a certificate repository which is unique to a user will now be described.

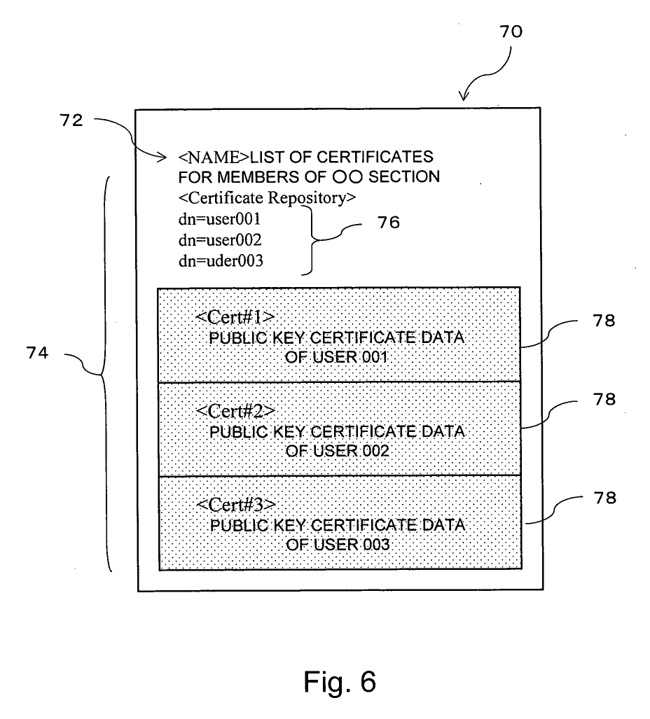

FIG. 6 shows an example of instruction data which are used as a certificate repository. Instruction data 70 which are shown in FIG. 6 include name of instruction data 72 and certificate repository information 74. The certificate repository information 74 includes each public key certificate 78 included in the instruction and a list 76 of distinguished names (DN) of the subjects of the public key certificates.

When the instruction editor 22 receives a command to create an instruction indicating a certificate repository, the instruction editor 22 displays a list of public key certificates which are installed in the PC 20 or a screen for searching the directory server for public key certificates, in order to allow selection of a public key certificate. When the user or the instruction creator selects, from the list or the search result, one or more public key certificates corresponding to one or more users having full access rights or one or more people to which the encrypted data are to be transmitted, the instruction editor 22 creates instruction data including the public key certificate and distinguished name in the certificate repository information 74.

A user can create instruction data including public key certificates which the user often uses and store the instruction data in the instruction pool server 30 so that the user can later download the instruction data to the multifunction center 10 and use the public key certificate by displaying on the display device the user's list of public key certificates.

Such an instruction of certificate repository is used in combination with another instruction which instructs a job. For example, when the certificate repository instruction is used in combination with an instruction indicating a process to encrypt a file of a scanned image, the list of public key certificates included in the certificate repository instruction is used as selection choices of the public key to be used for encryption (that is, the user to which the encrypted file is to be provided). When the certificate repository instruction is used in combination with an instruction indicating a process to set an operation restriction or a user having full access rights to a file of a scanned image, for example, the list of the public key certificates included in the certificate repository is used as the selection choices from which the user having full access rights is to be selected.

In either configuration, the certificate repository information 74 also functions as an address book for the user.

In the above-described configuration, an instruction indicating a job and an instruction showing a certificate repository are used in combination. Alternatively, it is also possible to employ a configuration in which the certificate repository information 74 (76 and 78) is incorporated in an instruction indicating a job.

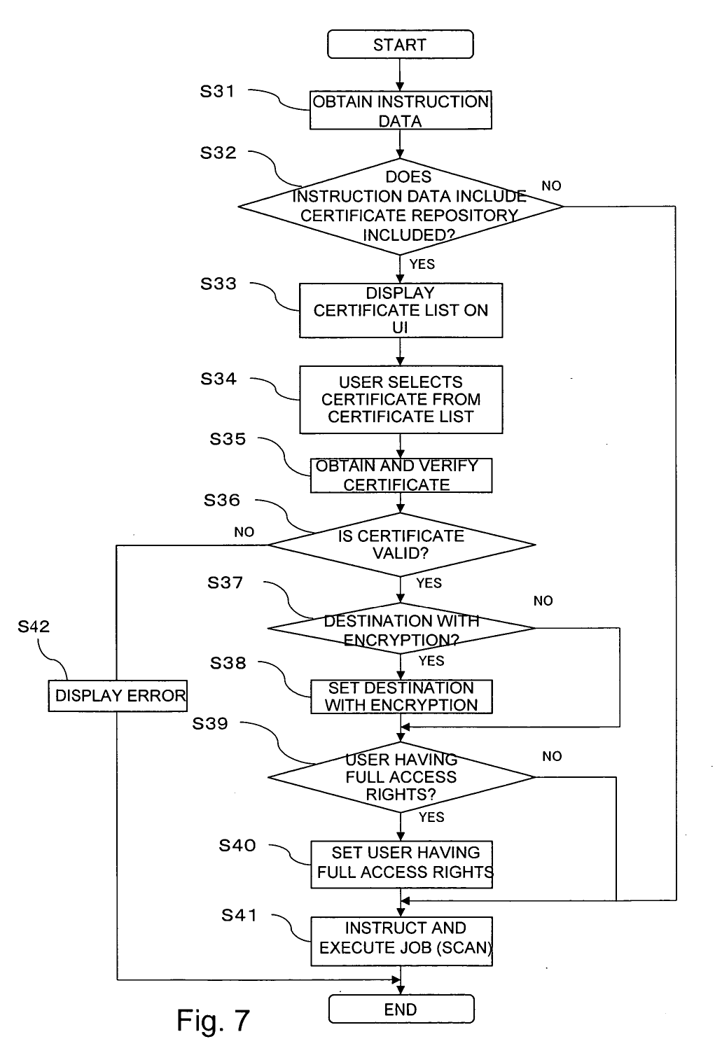

FIG. 7 shows a processing performed by the multifunction center 10 when the multifunction center 10 processes an instruction including the certificate repository information 74. In this example, it is assumed that an instruction including a scanning instruction and certificate repository information 74 (the two instructions may be separate) is downloaded to the multifunction center 10.

In this process, when the multifunction center 10 obtains, from the instruction pool server 30, the instruction selected by the user (S31), the multifunction center 10 determines whether or not the instruction includes the certificate repository information 74 (S32). If the instruction does not include the certificate repository information 74, the instruction executing section 16 simply executes the job indicated in the instruction (in this case, scanning of a document) (S41). When the instruction includes a designation of a storage destination or a transmission destination of the scanned file, the instruction executing section 16 stores or transmits the scanned file according to the designation.

When it is determined in step S32 that the instruction includes the certificate repository information 74, the instruction executing section 16 creates a list of public key certificates included in the certificate repository information 74 and displays the list on the display device of the multifunction center 10 (S33). It is also desirable to employ a configuration in which the displaying function of the list is called in response to a request by the user. More specifically, there may be employed a configuration in which, for example, a button for calling the certificate list is displayed on an initial screen of the display device along with the GUI button for other operations, and a screen of the list of the public key certificates is displayed when the button of the certificate list is pressed.

In some cases, the multifunction center 10 may store a shared address book shared by multiple users who use the multifunction center 10, and the public key certificate of each destination user may be registered in the address book. In such a case, both the list of the public key certificates included in the instruction and the shared address book may be displayed.

In the displaying process of the list of public key certificates, there may be displayed a list of distinguished names or mail addresses (which are also included in the certificate) of the subjects of the public key certificates.

The user selects one or more public key certificates from the displayed list (S34) . The instruction executing section 16 of the multifunction center 10 receiving the selection result obtains the selected public key certificate from the certificate repository information 74 or shared address book and verifies whether or not the public key certificate is valid through a method similar to that described above (S35). As a result of the verification, a determination is made as to whether or not the certificate is valid (S36). When the certificate is valid, a determination is made as to whether or not the instruction instructs encryption of the scanned file (S37), and, when the instruction is an encryption instruction, the public key certificate selected in step S34 is set in the file creating section 14 as the destination of the encrypted file (S38). When, on the other hand, the instruction is not an encryption instruction, step S38 is skipped. The instruction executing section 16 determines whether or not the instruction instructs setting of the user having full access rights (S39), and, when the instruction instructs the setting, sets the public key certificate selected in step S34 in the file creating section 14 as information of the user having full access rights (S40). When setting of the user having full access rights is not instructed, step S40 is skipped.

The instruction executing section 16 then instructs the image reading section 12 to scan a document, and instructs the file creating section 14 to create a scanned file representing the obtained scanned image (S41). In this process, if the encryption destination is set in step S38, the file creating section 14 encrypts the contents of the scanned file in a process similar to that described above, by means of the public key certificate of the destination. Moreover, when the user having full access rights is set at step S40, the user having full access rights is set for the scanned file by means of the public key certificate of the user.

When, on the other hand, it is determined in step S36 that the public key certificate is not valid, the instruction executing section 16 displays an error, such as a message indicating that invalid certificate has been selected, on the display device of the multifunction center 10 (S42), and the process is completed without the scanning process.

In the above-described configuration, the instruction instructs one of the encryption of the scanned file and the setting of the user having full access rights with respect to the scanned file. It is also possible to employ a configuration in which both of these processes are instructed in the instruction. When both processes are instructed, in step S34 the user can individually select the public key certificate of the destination of the encrypted file and the public key certificate of the user having full access rights.

In the above description, a case is exemplified in which an instruction including the instruction for job and the certificate repository information 74 is processed by the multifunction center 10. The present invention, however, is not limited to such a configuration and may be applied to a configuration in which the instruction of the job is performed from a menu screen of the multifunction center 10 and only the certificate repository information 74 is used from the instruction.

According to this embodiment, the user can create instruction data including certificate repository information containing public key certificates which the user often uses and store the instruction data in the instruction pool server 30, to allow the user to obtain and use, in scanning of a document in any multifunction center 10, the public key certificate the user often uses, by downloading the stored instruction data from the server 30.

In the embodiment and the alternative embodiment of the present invention as described above, a configuration is shown in which instruction data created by the instruction editor 22 are stored in the instruction pool server 30 and the user downloads and uses the instruction from the server 30 as necessary. However, the present invention is not limited to such a configuration, and the above-described mechanism can be applied to a system configuration in which the user stores the instruction data created by means of the instruction editor 22 in a transportable recording medium such as a USB (Universal Serial Bus) memory and carries the transportable recording medium, and the multifunction center 10 reads and executes the instruction data from the recording medium.

In the above-described configuration, the instruction editor 22 is installed in the PC 20. The present invention is not, however, limited to such a configuration, and there may be employed a configuration in which, for example, an application service provider provides the functions of the instruction editor 22 to the PC 20 on demand.

Although a preferred form of the present invention has been described with a certain degree of particularity using specific examples, it is to be understood that the invention is not limited thereto. Further, it is understood by those skilled in the art that various changes and modifications may be made to the invention without departing from the spirit and scope thereof.

What is claimed is:

1. A job processing system comprising an instruction creating device and an image reading device, wherein
the instruction creating device comprises:
a section that accepts designation of a public key certificate of a user having full access rights with respect to an electronic document file including a read image, and
a section that creates reading instruction data including data indicating the operation restriction and data indicating the designated public key certificate of the user having full access rights, and
the image reading device comprises:
a section that detects, from reading instruction data, data indicating an operation restriction and data indicating a public key certificate of a user having full access rights when the section receives a document reading instruction by the reading instruction data; and
a section that sets, when the data indicating the operation restriction are detected from the reading instruction data, an operation restriction, on the basis of the read data to an electronic document file representing an image obtained by reading a document and that sets, when the data indicating the public key certificate of the user having full access rights are detected from the reading instruction data, a user having full access rights, on the basis of the read data to the electronic document file representing the image obtained by reading the document.

2. A job processing system according to claim 1, wherein
the instruction creating device further comprises a section that accepts designation of an operation restriction with respect to an electronic document file including a read image.

3. A job processing system according to claim 1, wherein
the instruction creating device further comprises a section that judges validity of the public key certificate of the user having full access rights and executes predetermined error processing when the public key certificate is judged to be invalid.

4. A job processing system according to claim 1, wherein
the instruction creating device stores the created reading instruction data in a predetermined instruction pool server, and
the image reading device further comprises:
a user interface that allows selection of reading instruction data stored in the instruction pool server; and
a section that downloads, from the instruction pool server, reading instruction data selected by the user through the user interface.

5. An instruction creating device comprising:
a section that accepts designation of a public key certificate of a user having full access rights with respect to an electronic document file including a read image; and
a section that creates reading instruction data including data indicating the operation restriction and data indicating the designated public key certificate of the user having full access rights.

6. An image reading device comprising:
a section that detects, from reading instruction data, data indicating an operation restriction and data indicating a public key certificate of a user having full access rights when the section receives a document reading instruction by the reading instruction data; and
a section that, when the data indicating the operation restriction are detected from the reading instruction data, sets an operation restriction on the basis of the read data to an electronic document file representing an image obtained by reading a document and that sets, when the data indicating the public key certificate of the user having full access rights are detected from the reading instruction data, a user having full access rights, on the basis of the read data to the electronic document file representing the image obtained by reading the document.

7. A job processing system comprising an instruction creating device and an image reading device, wherein
the instruction creating device comprises a section that creates certificate repository instruction data including data of one or more public key certificates; and
the image reading device comprises:
a section that displays, on a display screen of the image reading device, a list of public key certificates included in input certificate repository instruction data and accepts selection from the list of a public key certificate to be used by a user; and
a section that encrypts, by means of the selected public key certificate, an electronic document file representing an image obtained by reading a document or that sets, by means of the selected public key certificate, a user having full access rights to the electronic document file representing the image obtained by reading the document.

8. A job processing system according to claim 7, wherein
the instruction creating device stores the created instruction data in a predetermined instruction pool server, and
the image reading device further comprises:
a user interface that allows selection of instruction data stored in the instruction pool server; and
a section that downloads, from the instruction pool server, certificate repository instruction data selected by the user through the user interface.

9. An image reading device comprising:
a section that displays, on a display screen of the image reading device, a list of public key certificates included in input certificate repository instruction data and accepts selection from the list of a public key certificate to be used by a user, and
a section that encrypts, by means of the selected public key certificate, an electronic document file representing an image obtained by reading a document or that sets, by means of the selected public key certificate, a user having full access rights to the electronic document file representing the image obtained by reading the document.
